(19) United States
(12) Patent Application Publication
(10) Pub. No.: US 2022/0358343 A1
(43) Pub. Date: Nov. 10, 2022

(54) ARCHITECTURE, SYSTEM, AND METHOD FOR SIMULATING DYNAMICS BETWEEN EMOTIONAL STATES OR BEHAVIOR FOR A MAMMAL MODEL AND ARTIFICIAL NERVOUS SYSTEM

(71) Applicant: Soul Machines Limited, Auckland (NZ)

(72) Inventor: Mark SAGAR, Auckland (NZ)

(21) Appl. No.: 17/621,616

(22) PCT Filed: Jul. 3, 2020
(86) PCT No.: PCT/IB2020/056280

§ 371 Date: Dec. 21, 2021

(30) Foreign Application Priority Data
Jul. 3, 2019 (NZ) 755124

(51) Int. Cl. G06N 3/00

(52) U.S. Cl. CPC G06N 3/006

(57) ABSTRACT

Embodiments of architecture, systems, and methods for modeling dynamics between behavior and emotional states in an artificial nervous system are described herein. A computer implemented emotion system of an artificial nervous system for animating a virtual object, digital entity, or robot, is provided, comprising: a plurality of states, each state of the plurality of states representing an emotional state (ES) of the artificial nervous system; a module for processing a plurality of inputs, the processed plurality of inputs applied to the plurality of states. Other embodiments may be described and claimed.

### TECHNICAL FIELD

Various embodiments described herein relate to apparatus and methods for simulating behavior and emotion state(s) for a mammal model and an artificial nervous system.

### BACKGROUND INFORMATION

It may be desirable to simulate dynamics between behavior and emotional states for a mammal model and an artificial nervous system. Embodiments herein provide architecture, systems, and methods for same.

### BRIEF DESCRIPTION OF THE DRAWINGS

FIG. 1 is a simplified diagram of dynamics or pathology between emotional states or behaviors of an artificial nervous system according to various embodiments.

FIG. 2A is a simplified diagram of a module simulating the dynamics or pathology between two emotional states or behaviors according to various embodiments.

FIG. 2B is a simplified diagram of a module simulating the dynamics or pathology between three emotional states or behaviors according to various embodiments.

FIG. 2C is a simplified diagram of a module simulating the dynamics or pathology between eight emotional states or behaviors according to various embodiments.

FIG. 3A is a diagram of a multiple input data processing module that may generate signals or weights for module(s) shown in FIGS. 2A-2C according to various embodiments.

FIG. 3B is a diagram of a plurality of multiple input data processing modules where each module may generate signals or weights for a module shown in FIGS. 2A-2C according to various embodiments.

FIG. 4A is a simplified block diagram of a data processing module network that may generate signals or weights for module(s) shown in FIGS. 2A-2C and FIGS. 4B-4C according to various embodiments according to various embodiments.

FIG. 4B is a diagram of a dynamical system for modeling emotions according to various embodiments.

FIG. 4C is diagram of a subcortical circuit according to various embodiments.

FIG. 4D is a graph illustrating how stimulus inputs affect emotion according to various embodiments.

FIG. 4E is a diagram illustrating neural density of prediction error as an emotional trigger according to various embodiments.

FIG. 4F is a diagram illustrating how emotion may induce new solution approaches according to various embodiments.

FIG. 5A is a block diagram of a hardware module according to various embodiments.

FIG. 5B is a block diagram of another hardware module according to various embodiments.

FIG. 6A is a simplified diagram of a user perceptible device providing a digital representation of a mammal model according to various embodiments.

FIG. 6B is a simplified diagram of an anatomical representation of a mammal model according to various embodiments.

### DETAILED DESCRIPTION

In an embodiment, the dynamics between emotional state(s) or behavior(s) of an artificial nervous system may be simulated. In one embodiment, the artificial nervous system is a standalone artificial nervous system that is not modeled on an organism. In another embodiment, the artificial nervous system may represent or simulate an avatar, such as a virtual organism representing any kind of animal or creature. In one embodiment, the artificial nervous system represents or simulates a mammal model.

In another embodiment, the artificial nervous system animates a physical robot. The robot may include sensors tied to the real world (such as a camera, microphone, touch sensors or any other suitable sensors). The robot may include effectors/motors/actuators such as limbs, an animatable facial structure, speakers for audible output, or any other suitable actuators/effectors.

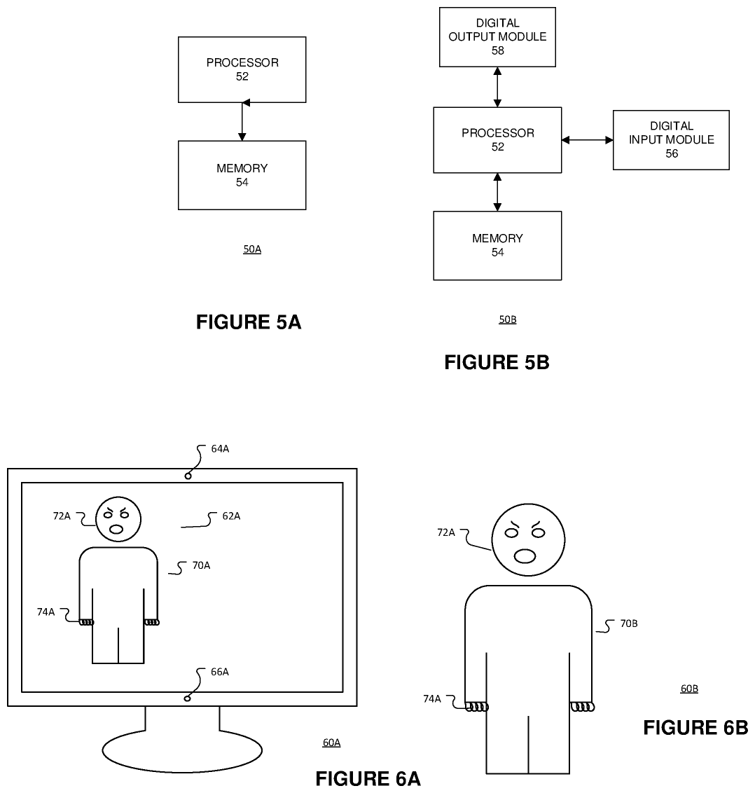

In an embodiment, an avatar, such as a mammal model, may be presented to or perceived by a User via a user perceptible format such as image 62A on a screen 60A as shown in FIG. 6A or an anatomical model 60B as shown in FIG. 6B. As shown in FIG. 6A, an avatar in an embodiment 70A, may have one or more simulated emotional state(s). An emotional state as discussed here may include a combination of visceromotor and motor activity induced by exteroceptive and interoceptive context. A User may perceive an avatar's emotion by the avatar's facial expression(s) 72A, body language 74A, or speech projected via a speaker 66A. In an embodiment, the emotional state(s) or behavior(s) of an avatar may be presented in an at least partial anatomical representation of the avatar 60B as shown in FIG. 6B.

In either embodiment, emotional state(s) or behavior(s) of an artificial nervous system may vary or change due to dynamics between the states and behavior. In an embodiment, the dynamics between states or behavior may be affected or influenced by a projected or perceived environment where such perceptions may be projected onto the avatar. The perceptions may include various sensory perceptions including visual, audial, olfactory (smell), taste, and tactical (touch). Perceptions from a real-world environment way be provided to the avatar through sensors such as a camera, microphone, touch sensors, or any other suitable sensors.

In an embodiment, the behavior may be any agent driven process. Behavior may include any conduct or actions including but not limited to facial expression(s) 72A, body language 74A, speech projected via speaker 66A, and so on. More generally, behavior may comprise any mathematical solver which activates different routines based on progress measures that are dynamically monitored, modulated, or controlled by an emotion system. The emotion system may be affected by density of neural firing and in one embodiment is affected by density of prediction error from a plurality of levels or differentials.

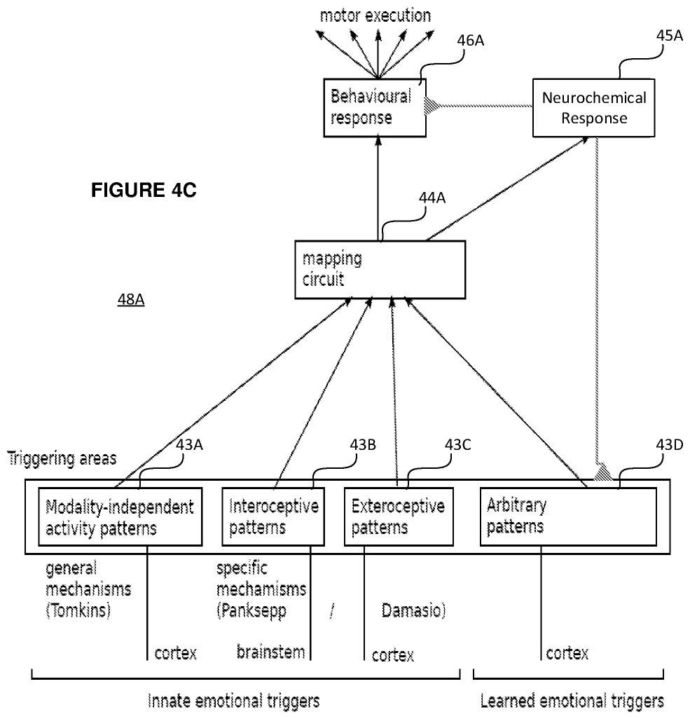

In an embodiment, an anatomical representation of the avatar 60B may include sensors or a system 50B (FIG. 5B) may include one or more sensors that detect various senses in its environment. Similarly, a digital system 50B that generates the digital representation 70A of an avatar may include sensors to detect one or more senses in its environment. A system 60B may also receive sensor information to be applied an avatar 70A, 60B from the system 50B or other system coupled to the system 50B, such a computer program where the avatar is part of the program (such as a game, artificial reality device, virtual reality device, or other digital source).

In an embodiment, a digital system 50B digital input module 56 may include visual sensors to collect and provide visual sensory data (normal or broad spectrum). The input module 56 may also include one or more microphones to collect and provide audio sensory data (normal or beyond mammal normal audio range). The input module 56 may further include a device to receive air samples to be chemically tested to detect olfactory signals that may be provided in a digital representation. The input module 56 may include a device to receive physical samples to be chemically tested to detect the presence of elements that a mammal can taste and provide a digital representation such tastes including the detected sodium chloride level (tastes salty), sugar compound level (tastes sweet), acid level (tastes sour), pepper level (causes pain), and others. The input module 56 may also include a touchpad or other device that enables a User to provide an indication of level(s) of touch at various locations on the avatar 70A, 60B.

In an embodiment, the avatar's 70A, 70B current emotional state(s), combination of sensory inputs, and their intensity may be evaluated to determine or simulate dynamics between emotional state(s) or behavior(s). As noted in an embodiment, one or more sensory inputs themselves may be part of a digital reality of an avatar60A. In an embodiment, an avatar 60A, 60B may have numerous simulated emotional state(s) or behavior(s) similar to a physical mammal where the levels of each simulated emotional state or behavior is determined in part based on analysis of physical mammals. Such analysis may include the physical mammal brain functions and perceived dynamics between certain emotional states and behavior in physical mammals.

In a physical mammalian brain, various neural activation of motor behaviour circuits and visceromotor circuits driving release of neurochemicals may be generated in different brain regions in response to sensory inputs. The level of neurochemical generation may also vary as a function of the sensory input intensity. In addition, certain sensory inputs may affect different cortical and subcortical regions of the brain (conscious and sub-conscious regions) and create perceived dynamics between certain emotional states and behavior in physical mammals. For example, the amygdala and hypothalamus may be involved in the creation of several emotional states (an emotional state as discussed here is a combination of visceromotor and motor activity induced by external and internal context) or behaviors including fear responses, emotional responses, hormonal secretions, arousal, and memory.

In addition, the hippocampus, a small organ located within the brain's medial temporal lobe may form an important part of the limbic system and may regulate a physical mammal's emotions. The hippocampus may also encode emotional context from the amygdala and cortex. The hypothalamus links to brain glands such as the pituitary gland and other glands such as those controlled by brainstem nuclei (e.g. Locus coeruleus) may generate neurochemicals that may help regulate the dynamics between emotion states or behaviors. The neurochemicals released by upstream activity of the amygdala and hypothalamus and brainstem nuclei may include dopamine, serotonin, norepinephrine (NE), and oxytocin.

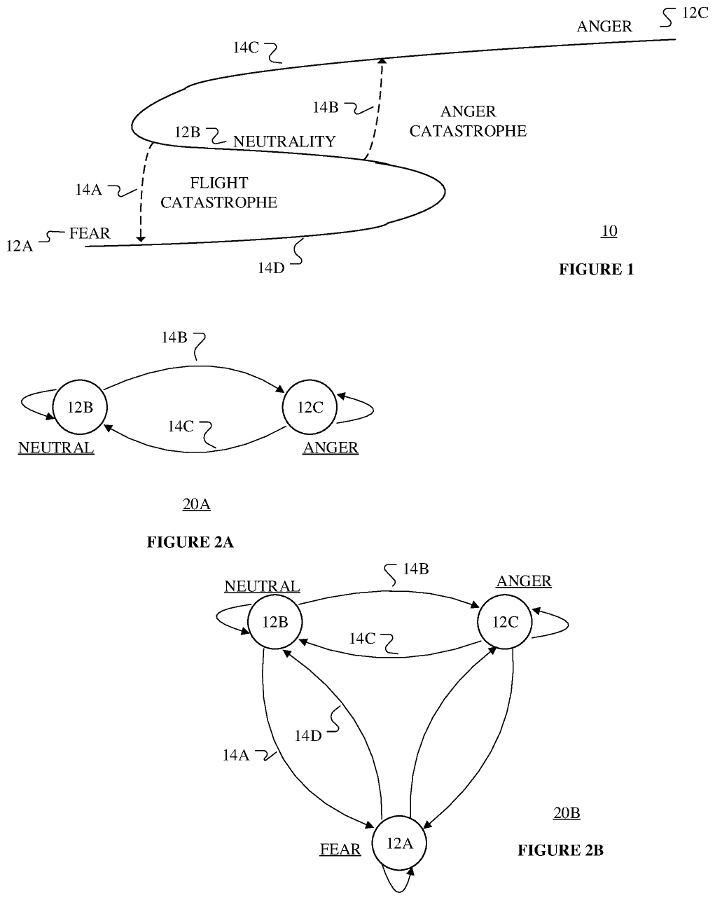

In an embodiment, the avatar's emotional state(s) may be simulated by creating a dynamic model between various emotional states or behavior such as shown in FIG. 1. The measured or generated sensory inputs and their intensity, alone or combined over time and derivatives thereof (how quickly they change) of an avatar 70A, 70B may be used to effectively generate or simulate the various neurochemicals that may be generated by sensory inputs in an embodiment. As explained with reference to FIG. 1, the simulated neurochemical or measured or generated sensory inputs may be used to simulate the dynamics between competing emotional stages or behaviors of physical mammal in an avatar 70A, 70B and determine the avatar's current or active emotional state(s) or behavior(s).

FIG. 1 is a simplified dynamics or pathology 10 between emotional states or behaviors 12A-C of an artificial nervous system according to various embodiments. As shown in FIG. 1, competing emotional states (ES) may include the ES Fear 12A, the ES neutrality 12B, and the ES anger 12C. In an embodiment, an artificial nervous system may be considered to have different levels (from 0 to 100 percent in an embodiment) of each ES 12A-C. The dynamics or pathology 10 may be employed to simulate the change of the different ES 12A-C levels due the present of inputs (neurochemical, sensory, or combination thereof) over time.

As shown in FIG. 1, the dynamic or pathology 10 between certain emotional states may vary based on current ES 12A-C levels, the respective delta or different of change in the ES 12A-C. For example, when the ES 12C for anger is increasing it may do so in a short time interval or may require a lower sensory or neurochemical present or input via pathway 14B. Similarly, when the ES 12A for fear is increasing it may do so in a short time interval or may require a lower sensory or neurochemical present or input via pathway 14A. However, when the ES 12C for anger is decreasing it may take a longer time interval or may require a greater sensory or neurochemical present or input via pathway 14C. Similarly, when the ES 12A for fear is decreasing it may take a longer time interval or may require a greater sensory or neurochemical present or input via pathway 14D. In each of these scenarios, the modeled neurochemical or sensory input may need to exist or not exist for the time interval for the various ES 12A-C levels to change. In an embodiment, a dynamic between the various ES 12A-C always exists and is simulated.

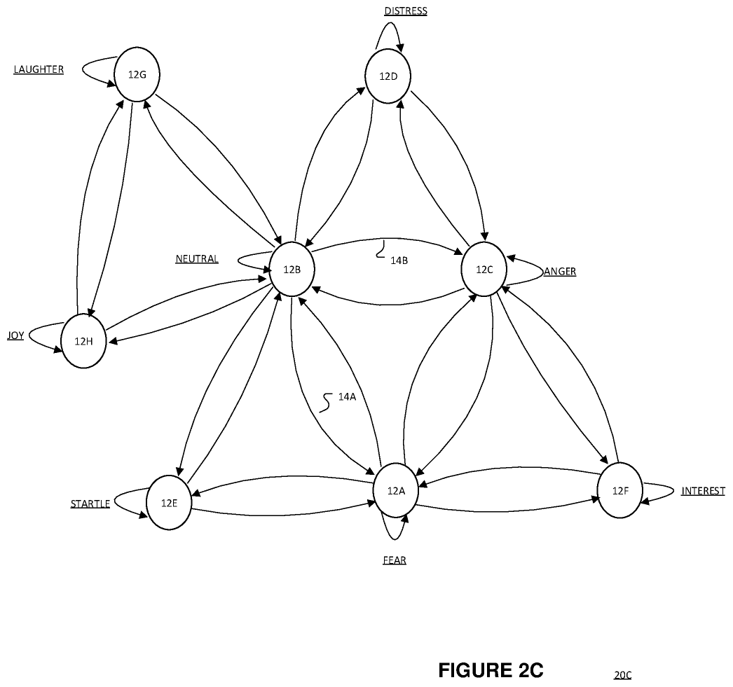

In an embodiment, the dynamic between the various ES 12A-C as shown in FIG. 1 may be simulated recurrent modules 20A-C as shown in FIGS. 2A-2C. In the modules 20A-C, each emotional state or behavior 12A-H may be a state of a network or a neuron that is in feedback loop with itself and every other state or neuron in the module 20A-C. The effective level of each emotional state or behavior as represented by a network state or neuron 12A-H in FIGS. 2A-C may vary as a function of the simulated neurochemical or sensory inputs, their intensity, duration, and rate of change.

FIG. 2A is a simplified diagram of a module 20A simulating the dynamics or pathology between two emotional states or behaviors 12B-C according to various embodiments. As shown in FIG. 2A, the simulation module 20A includes two neurons or network states 12B and 12C representing the ES neutral (12B) and ES anger (12C). As also shown in FIG. 2A, the module 20A includes pathways 14B and 14C between the states or neurons 12B and 12C similar to the pathways shown in FIG. 1. The change if any between states 12B and 12C is subject to the feedback between states 12B, 12C and themselves. In an embodiment, the change in level of each state 12B-C, may vary based on the attempted direction of the change (higher or lower) and the simulated neurochemical or sensory inputs, their intensity, duration, and rate of change.

FIG. 2B is a simplified diagram of a module 20B simulating the dynamics or pathology between three emotional states or behaviors 12A-C according to various embodiments. As shown in FIG. 2B, the simulation module 20B includes three neurons or network states 12A-C representing the ES fear (12A), ES neutral (12B), and ES anger (12C). As also shown in FIG. 2B, the module 20B includes pathways 14B and 14C between the states or neurons 12B and 12C and the pathways 14A and 14D between the states or neurons 12A and 12B similar to the pathways shown in FIG. 1. The change if any between states 12A-C is subject the feedback between states 12A-C and themselves. In an embodiment, the change in level of each state 12A-C, may vary based on the attempted direction of the change (higher or lower) and the simulated neurochemical or sensory inputs, their intensity, duration, and rate of change.

A similar module may be created for any number of ES. For example, FIG. 2C is a simplified diagram of a module 20C simulating the dynamics or pathology between eight commonly reported emotional states or behaviors 12A-H according to various embodiments. As shown in FIG. 2C, the simulation module 20C includes three neurons or states 12A-H representing the ES fear (12A), ES neutral (12B), ES anger (12C), ES distress (12D), ES startle (12E), ES interest (12F), ES laughter (12G), and ES joy (12H). Similar to modules 20A and 20B, the change if any between states 12A-H is subject the feedback between states 12A-H and themselves.

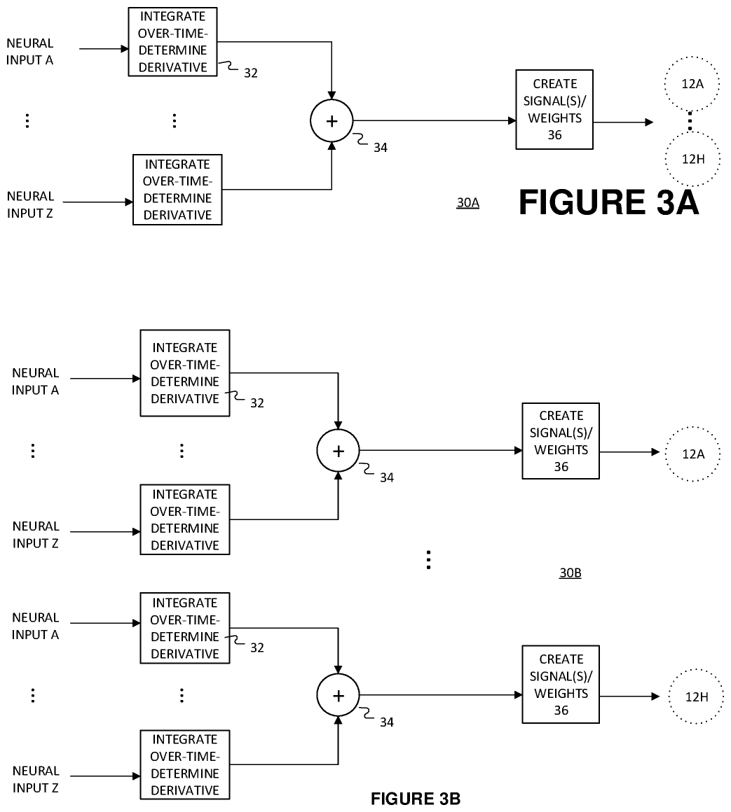

In an embodiment, the change in level of each state 12A-H, may vary based on the attempted direction of the change (higher or lower) and the simulated neurochemical or sensory inputs, their intensity, duration, and rate of change. FIG. 3A is a diagram of a multiple input data processing module 30A that may generate signals or weights for states(s) 12A-H shown in FIGS. 2A-2C according to various embodiments based on simulated neurochemical or sensory inputs, their intensity, duration, and rate of change. FIG. 3B is a diagram of a plurality of multiple input data processing modules 30B where each module may generate signals or weights for a state 12A-H shown in FIGS. 2A-2C according to various embodiments.

As shown in FIGS. 3A and 3B, each multiple input data processing module 30A may receive a plurality of neural inputs A to Z. In an embodiment, the neural inputs may represent simulated neurochemical or sensory inputs and their intensity. Each module 30A may then integrate each neural input A to Z over time and determine derivatives of the inputs also via module 32. The modules 30A, 30B may sum the integrated, original, and derivates of neural inputs A to Z via summer 34. The summed integrated, original, and derivates of the neural inputs A to Z may be processed to generate weights and signals for each state 12A-Z of the modules 20A-C via module 36 in an embodiment. In an embodiment, input data processing module 30A may generate weights and signals for all states 12A-Z of the modules 20A-C as shown in FIG. 3A. In an embodiment, separate modules 32, 36, and summer 34 may generate weights and signals for each state 12A-Z of the modules 20A-C as shown in FIG. 3B.

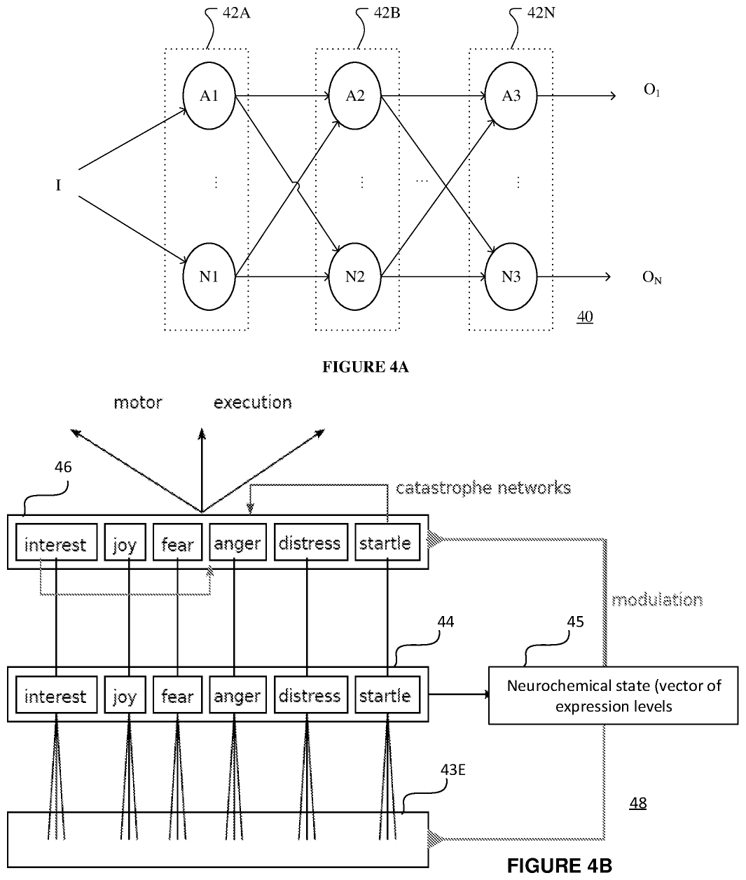

FIG. 4A is a diagram of a feed forward, learning data processing module network or instance 40 that may be employed in an emotional state 12A-H of a dynamic emotional state system 20A-C, to process neural inputs A to Z, or process the signals generated by the modules 30A, 30B according to various embodiments. The network 40 includes a plurality of layers 42A, 42B to 42N and each layer 4A, 42B to 42N includes one or more data processing or computational unit modules (DPM) A1 to N1, A2 to N2, and A3 to N3, respectively. Each DPM A1 to N1, A2 to N2, and A3 to N3 receives data or a data vector and generates output data or data vector.

Input data or a data vector I may be provided to the first layer 12A of data processing modules (DPM) A1 to N1 where the input data vector I may be generated a multiple input data processing module network 3A, 3B. As noted, the signals generated by the modules 30A, 30B may form the input data vector I in an embodiment. In an embodiment each DPM 1A to A1 to N1, A2 to N2, and A3 to N3 of a layer 42A, 42B, 42C may be fully connected to adjacent layer(s) 42A, 42B, 42N DPM A1 to N1, A2 to N2, and A3 to N3. For example DPM A1 of layer 42A may be connected to each DPM A2 to N2 of layer 42B.

In an embodiment the network 40 may represent a neural network and each DPM A1 to N1, A2 to N2, and A3 to N3 may represent a neuron. Further, each DPM A1 to N1, A2 to N2, and A3 to N3 may receive multiple data elements in a vector and combine same using a weighting algorithm to generate a single datum. The single datum may then be constrained or squashed with a constraint of 1.0 (or squashed to a maximum magnitude of 1.0) in an embodiment. The network may receive one or more data vectors that represent a collection of features where the features may represent an instant in time.

In an embodiment the network 40 may receive input training vectors with a label or expected result or prediction such as staying the current emotional state 12A-12G and sending control to another emotional state 12A-12G. In another embodiment, the network 40 may receive input training vectors with a label or expected result or prediction of the desired control signals for states 12A-12G based on the signals generated by the modules 30A, 30B. The network 40 may employ or modulate weighting matrixes to reduce a difference between the expected result or label and a result or label predicted by the network, instance, or model 40. An error or distance E may be determined by a user defined distance function in an embodiment. The network or model 40 may further include functions that constrain each layer's DPM A1 to N1, A2 to N2, and A3 to N3 magnitude to attempt to train the model or network 40 to correctly predict a result when corresponding input vectors are presented to the network or model 40 as input(s) I. In the network 10A each DPM 3A to 3N of the final layer 12N may provide an output data, predicted result, or data vector O1 to ON. In an embodiment, the data vector may determine which state should have control.

FIG. 4B is a diagram of a subcortical circuit 48A in some embodiments. Subcortical circuit 48A may be implemented in a computer system such as 50A and 50B and model the behavioral response of the system for a single emotion, such as any of states 12A-12H. First, an emotionally competent stimulus may be received as input to triggering areas. An emotionally competent stimulus may be, for example, tactile, visual, aural, olfactory, and so on. Triggering areas correspond to portions of the brain that respond to triggers to the system and may be modeled by one or more neurons, such as neural networks. Triggering areas may include modality-independent activity patterns 43A, which comprise triggers not limited to a particular perceptual pathway. For example, modality independent activity patterns 43A may be a quick trigger or a sustained trigger, regardless of whether the trigger is tactile, visual, or aural. These may be considered general mechanisms not limited to a particular modality and may reside in and be modeled by a model of the cortex. In some embodiments, the modality-independent activity patterns 43A may respond to rate of change of a stimulus over time and level of sustained activity of a stimulus over time. Triggering areas may also include interoceptive patterns 43B, which are triggers related to sensing the internal state of the body or artificial nervous system. Interoceptive patterns 43B may be considered specific mechanisms and may reside in and be modeled by a model of the brainstem and specialized regions of the cortex such as the insula and anterior cingulate. Triggering areas may also include exteroceptive patterns 43B, which are triggers related to sensing features external to the state of the body or artificial nervous system. Exteroceptive patterns 43B may be reside in and be modeled by a model of the cortex. Moreover, triggering areas may include arbitrary patterns 43D, which may be learned emotional triggers, such as a Pavlovian response resulting from training the body or artificial nervous system to associate a trigger with an emotion. Arbitrary patterns 43D may reside in and be modeled by a model of the cortex. Modulation may affect the triggering circuits 43 themselves (e.g. sensitive or desensitize) as well as the behavioural response 46A.

Triggering areas 43A-D may comprise innate triggers, hardwired triggers, and learned triggers. Innate triggers may include triggers based on neural firing, such as modality-independent activity patterns 43A. The triggers may be based on the connections between neurons and the activity on those connections, as modulated via attention, neurochemicals, and so on. Innate triggers may also be hardwired, which go directly to a behavioral response circuit without being modeled with neural firing. In one embodiment, interoceptive patterns 43B and exteroceptive patterns 43C are hardwired. One example of hardwiring may be pain, which may be hardwired to a behavioral response. However, in other embodiments, interoceptive patterns 43B and exteroceptive patterns 43C are also based on neural firing through neural networks. For example, a pain or reward stimulus may induce a burst of neural firing that causes a behavior. Thus, innate triggers may be either hardwired or based on neural firing, and a combination of both approaches may be used.

Learned triggers are based on a mapping between stimulus and an emotion. In this manner, an arbitrary pattern 43D may be connected to an emotion. For example, a bell may be associated with a negative emotion if the bell is presented just before a negative stimulus is presented. A neural network, associative map, or other model may develop an association between the otherwise arbitrary stimulus, the bell, and an emotion that has been perceived in the presence of that stimulus.

Triggers may be transmitted to the mapping circuit 44A, which for simplification is shown here to collectively model the hypothalamus and/or other subcortical nuclei causing visceromotor and motor activity. The mapping circuit may comprise a plurality of neurons, such as a neural network, and model a hypothalamus/subcortical nuclei response for a single emotion. The mapping circuit 44A may trigger one or more of a plurality of (motor) behavioral responses 46A. More complex embodiments may involve further mapping in the cortical regions potentially involved in emotional processing and behavioural response such as the Anterior Cingulate.

After processing the signal, the mapping circuit 44A transmits a signal output to a modulatory (visceromotor) neurochemical response model 45A. The neurochemical response model 45A models the release of neurochemicals in a body or artificial nervous system. Neurochemical response model 45A may comprise a plurality of neurons, such as a neural network. The mapping circuit 44A also transmits a signal output to behavioral response 46A. Behavioral response 46A may comprise one or more neurons, such as a neural network. The behavioral response 46A may comprise any of the emotional states 12A-12H. The behavioral response may trigger motor execution by the body or artificial nervous system such as facial expression(s) 72A, body language 74A, or speech.

FIG. 4C illustrates a dynamical system 48 combining a plurality of subcortical systems. In an embodiment, the dynamical system 48 comprises a subcortical system for each emotion modeled by the system, such as each of states 12A-12H. Triggering areas 43E may comprise a plurality of triggering areas 43A, 43B, 43C, and 43D for each emotion (each emotion may have corresponding triggering areas 43A, 43B, 43C, and 43D). Similarly, mapping circuits 44 may comprise a separate mapping circuit 44A for each emotion. An output signal may be transmitted from the mapping circuits 44 to the neurochemical state 45, which may comprise a vector of expression levels of each neurochemical. The mapping circuits 44 may transmit an output signal to the behavioral response models 46. A behavioral response model 46A may be provided for each emotion. The behavioral response models 46 may comprise, for examples, emotional states 12A-12H.

The behavioral response models 46 may be connected to each other in multiple ways. First, a behavioral response model may inhibit another behavioral response model, such as interest inhibiting fear. Moreover, in some embodiments, mutual inhibition may be modeled with the behavioral response models both inhibiting the other. In some embodiments, the behavioral response model for each emotion inhibits the behavioral response model for all of the other emotions, as the behaviors each compete for attention and try to displace each other. Second, a behavioral response model may interact with other behavioral response models through a recurrent dynamical circuit. A recurrent dynamical circuit may model a catastrophe network, where catastrophe refers to an abrupt switch from one state to another (which may be positive or negative). The recurrent dynamical circuit may model complex behavior such as illustrated in dynamics or pathology 10, where behavior depends not just on the trigger but on the most recent current state.

Behavioral response models 46 may also be modulated by the neurochemical state 45. Neurochemical state may process the input from mapping circuits 44 and transmit an output signal the behavioral response models 46. The output signal may modulate the response of the behavioral response models 46. The modulation may model modulation occurring in a mammal due to release of certain neurochemicals.

The connections between behavioral response models 46 may be modeled for example by modules 20A, 20B, or 20C, where each behavioral response model for a single emotion corresponds to one of states 12A-12H. The connections between nodes of modules 20A, 20B, and 20C may model the inhibition and recurrent relationships between the behavioral response models 46. Each connection may model the potential transmission of a signal from one behavioral response model to another. Moreover, modulation by neurochemical state 45 may also be modeled by neural network inputs to the behavioral response models 46.

FIG. 4D is a graph 90 illustrating how stimulus inputs affect emotion in an artificial nervous system according to modality-independent activity patterns. The Y-axis measures the density of neural firing. The density of neural firing may be determined or influenced by a mapping function that maps from a characteristic of a stimulus input to a density of neural firing. For example, the mapping function may be a monotonic mapping between a characteristic of the stimulus input and the density of neural firing. Thus, the density of neural firing may be a measure on a monotonic scale. Any characteristic may be mapped such as intensity, musical pitch, entropy, and so on. For example, in some embodiments, a stronger tap corresponds to denser neural firing than a lighter tap, and a shout corresponds to denser neural firing than speaking in a regular tone. The X-axis measures time.

The rate of change of the stimulus affects the emotional state that is induced. When the density of neural firing increases quickly, the artificial nervous system is induced into a startled emotion 90A. If the rate of increase is somewhat slower, then the emotion induced is fear 90B. Finally, if the rate of increase is slow enough to be manageable for the artificial nervous system then the emotion induced is interest 90C.

As an example, a very sudden increase in density of neural firing may cause the experience of being startled 90A. When the density of neural firing is increasing over time at a slower rate an emotional state of fear 90B may be induced because the artificial nervous system is unable to cope with the increasing stimuli. Meanwhile, if the density of neural firing increases over time but at a rate that is manageable, then an emotional state of interest 90C is induced.

Sustained stimuli also affect emotional state. A sustained stimulus input at a high level may induce the emotional state of anger 90D. A sustained stimulus input at a somewhat lower level may induce the emotional state of 90E. In some embodiments, sustained stimulus input of any kind leads to negative emotional states, regardless of the character of the stimulus input. For example, even a pleasant melody may induce anger or frustration if played continuously over a long period of time. Likewise, receiving the same compliment over and over again may also lead the artificial nervous system to experience feelings of anger and frustration.

In an embodiment, a decrease in density of neural firing is associated with positive emotions. For example, an emotional state of joy 90F may be induced. The artificial nervous system may experience joy at the decreasing neural firing that causes it to feel less overwhelmed with stimuli.

FIG. 4E is a diagram illustrating that the neural density of prediction error in a body or artificial nervous system may be an innate emotional trigger. In one embodiment, prediction error is a non-dimensional stimulus input. A mapping function may monotonically map a high amount of prediction error to a high density of neural firing and a low amount of prediction error to a low density of neural firing. In some embodiments, if prediction error does not decrease, the artificial nervous system becomes frustrated and exhibits perturbed behavior that causes new solution approaches. Similarly, if the change of prediction error is manageable the animal shows interest.

In an embodiment, the artificial nervous system receives, at a first time, a first observation 80A that is an input. The input may be of any modality such as tactile, visual, aural, olfactory, or gustatory. The input may be of a positive, negative, or neutral valence, and examples include a tap, wave, noise, speaking, shouting, physical approaching object or body part, taste, smell, sound, music or melody, and so on. The input may include observations about the environment. The input 80A may be input to predictor 82, which may be machine learning model that makes a prediction 84 based on the input 80A. In some embodiments, the predictor 82 comprises one or more neurons, such as a neural network. In some embodiments, the prediction 84 comprises a prediction of what will happen based on the input 80A. The predictor 82 may optionally take into consideration the behavior of the artificial nervous system in generating prediction 84.

At a second time, the artificial nervous system may receive a second observation 80B. The second observation 80B may comprise a ground truth observation about the state of the world. The artificial nervous system may perform an error calculation 86 to compute the error between the prediction 84 of what the ground truth would be and the second observation 80B. For example, the error calculation 86 may be a subtraction operation of the second observation 80B from the prediction 84 or other error calculations such as least squares. This computes a prediction error 88, which is a value measuring the error in the prediction 84.

The prediction error 88 comprises a stimulus input for the modality-independent activity patterns 43A triggering area.

As a stimulus input, prediction error 88 may affect density of neural firing and thereby emotion in an artificial nervous system according to modality-independent activity patterns. With respect to graph 90, in the context of prediction error 88, the more the prediction 84 differs from the ground truth observation 80B the denser the activity of neural firing.

The rate of change of the prediction error 88 over time may affect the emotional state that is induced. When the prediction error 88 increases quickly, the artificial nervous system is induced into a startled emotion 90A. If the rate of increase is somewhat slower, then the emotion induced is fear 90B. Finally, if the rate of increase is slow enough to be manageable for the artificial nervous system then the emotion induced is interest 90C.

As an example, a very sudden difference between prediction and observed ground truth may cause the experience of being startled 90A. When the difference between prediction and observed reality is increasing over time at a slower rate an emotional state of fear 90B may be induced because the artificial nervous system observes rapidly increasing differences between expectation and reality and has an inability to understand or control observed reality. Meanwhile, if the difference between prediction and observed ground truth increases over time but at a rate that is manageable, then an emotional state of interest 90C is induced. The artificial nervous system is interested and curious in the differences experienced between the predicted and real outcomes.

Sustained prediction error 88 also affect emotional state. A sustained prediction error 88 at a high level may induce the emotional state of anger 90D. A sustained prediction error 88 at a somewhat lower level may induce the emotional state of 90E. Consistently making incorrect predictions about the world may lead to anger or frustration.

In an embodiment, a decrease in prediction error 88 is associated with positive emotions. A decrease in prediction error 88 over time may induce joy 90F where the artificial nervous system feels that the environment has become more predictable or that it has a better understanding and ability to predict outcomes.

FIG. 4F is a diagram 94 illustrating how the changes in emotional states may induce the artificial nervous system to try one or more new solution approaches. Current state 92 represents a current state of the world, which may comprise the state of one or more external objects and the physical state of the artificial nervous system. The artificial nervous system may influence the current state 92 through its behaviors. Current state 92 is in a local minima 94A, and the goal of the artificial nervous system is to reach global minima 94B comprising a solution state. When the prediction error 88 remains high, the artificial nervous system experiences anger 90D or frustration 90E and causes the artificial nervous system to act out on the environment. The artificial nervous system's perturbations of the environment can rapidly change the current state 92 and go up over slope 94C to reach global minima 94B. Also, when the artificial nervous system is in a state of interest or curiosity, the artificial nervous system may interact with the environment and perturb the current state 92 to reach global minima 94B. In some embodiments, the perturbation of current state 92 by the artificial nervous system to reach better solution states may correspond to or approximate simulated annealing. Simulated annealing is a probabilistic method for approximating the global optimum of a function.

FIG. 5A is a block diagram of a hardware module 50A that may be include one or more data processing modules A1 to N1, A2 to N2, A3 to N3, 12A-12Z, and modules 30A, 30B according to various embodiments. The module 50A may include a processor module 52 coupled to a memory module 54. In an embodiment the memory module 54 and processor module 52 may exist on a single chip. The processor module 52 may process instructions stored by the processor 52 or memory module 54 to perform the functions of one or more A1 to N1, A2 to N2, A3 to N3, 12A-12Z, and modules 30A, 30B. The processor module 52 may further process instructions stored by the processor 52 or memory module 54 to communication data or data vectors on a network.

FIG. 5B is a block diagram of a system 50B that may be employed by a User to control the operation of an artificial nervous system and provide inputs to models 70A, 70B, or run a program that simulates one or more inputs for an avatar 70A, 70B according to various embodiments. The system 50B may include a processor module 52 coupled to a memory module 54. In an embodiment the memory module 54 and processor module 52 may exist on a single chip. The processor module 52 may process instructions stored by the processor 52 or memory module 54 to perform various functions. The processor module 52 may further process instructions stored by the processor 52 or memory module 54 to communication data or data vectors on a network. The system 50B may also include a digital input module 56 and a digital output module 58. The digital input module 56 may enable a User to provide various inputs including neural inputs, sensory inputs and control other operations of one or more avatars 70A, 70B as described. The digital output module 58 may generate signals that may be displayed on a screen 60A or to control an anatomical representation of an avatar 70B.

The invention/s disclosed herein may be used within the context of a neurobehavioral modelling framework to create and animate an embodied agent or avatar is disclosed in U.S. Ser. No. 10/181,213B2, also assigned to the assignee of the present invention, and is incorporated by reference herein.

It should be understood that while an emotion system and behavior have been described in the context of a mammal model, the emotion system and behavior may be abstracted and used in models of other organisms or avatars or separately from an organism model. That is, they may be used in abstracted neural systems, such as a completely artificial nervous system that is not connected to an avatar.

The modules may include hardware circuitry, single or multi-processor circuits, memory circuits, software program modules and objects, firmware, and combinations thereof, as desired by the architect of the architecture 10 and as appropriate for particular implementations of various embodiments. The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within and couplable to a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion. A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

1-29. (canceled)

30. A computer implemented emotion system of an artificial nervous system, for animating a virtual object, digital entity, or robot, comprising: a plurality of states, each state of the plurality of states representing an emotional state (ES) of the artificial nervous system; a module for processing a plurality of inputs, wherein the module determines modality-independent activity patterns of the inputs over time, the processed plurality of inputs applied to the plurality of states, wherein a respective current level of one or more of the plurality states is affected by the application of the plurality of inputs and wherein the respective current level of one or more of the plurality states represents one of the active emotional states of the artificial nervous system.

31. The emotion system of claim 30, wherein the ES of the artificial nervous system are competing ES.

32. The emotion system of claim 30, wherein each of the plurality of inputs represents a neural input.

33. The emotion system of claim 32, wherein a neural input is a sensory input provided to the emotion system.

34. The emotion system of claim 30, further including an output module that conveys one or more of respective current levels of the active emotional states of the artificial nervous system to a User in a perceptible format.

35. The emotion system of claim 34, wherein the perceptible format is one of a visual format and an auditory format.

36. The emotion system of claim 35, wherein the perceptible format is a visual two-dimensional representation of at least a portion of a mammal model.

37. The emotion system of claim 30, wherein a module for processing a plurality of inputs integrates each of the plurality of inputs over time.

38. The emotion system of claim 30, wherein a module for processing a plurality of inputs determines the rate of change of each of the plurality of inputs over time.

39. The emotion system of claim 30, wherein a module for processing a plurality of inputs determines the rate of change of each of the plurality of inputs over time, sums all the plurality of inputs together, and sums all of the plurality of inputs determined rate of change.

40. The emotion system of claim 30, wherein a module for processing a plurality of inputs integrates each of the plurality of inputs over time, sums all the plurality of inputs together, and sums integrations of all of the plurality of inputs.

41. The emotion system of claim 30, including at least three states, representing three competing ES of the artificial nervous system.

42. The emotion system of claim 41, wherein less time is required to change from the 2nd state to the 1st state than the time required to change from 1st state to the 2nd state.

43. A computer implemented emotion system of an artificial nervous system, for animating a virtual object, digital entity, or robot, comprising: a plurality of states, each state of the plurality of states representing an emotional state (ES) of the artificial nervous system; a
predictor module computing a prediction error based at least in part on received sensory input associated with an occurrence of a type of stimuli, the sensory input corresponding to a neural input in a plurality of received inputs, the prediction error comprising a stimulus input causing a change in a current level of at least one active ES of the artificial nervous system.

44. The emotion system of claim 43, wherein the predictor module computes one or more predictions based at least in part on one or more received sensory inputs and computes one or more prediction errors based on respective predictions.

45. The emotion system of claim 43, wherein the stimulus input based on the prediction error corresponds to an amount of density of neural firing related to the change in the current level of at least one active ES in the artificial nervous system.

46. The emotion system of claim 45, wherein the artificial nervous system is configured to enter a perturbed state in response to a sustained amount of density of neural firing in response to prediction error.

47. The emotion system of claim 46, wherein the artificial nervous system is configured to enter a perturbed state in response to an increased amount of density of neural firing in response to prediction error.

48. The emotion system of claim 30 wherein one or more ES are represented by a network state of the artificial nervous system.

49. The emotion system of claim 30 wherein one or more ES are represented by a dynamic pattern of network activity of the artificial nervous system.
